(19) United States
(12) Patent Application Publication
(10) Pub. No.: US 2011/0159823 A1
(43) Pub. Date: Jun. 30, 2011

(54) RF Front-end Circuit and Wireless Communication Device Using the Same

(76) Inventors: Shao-Chin Lo, Miaoli County (TW); Min-Shun Hsu, Hsinchu City (TW)

(21) Appl. No.: 12/959,346

(22) Filed: Dec. 2, 2010

Related U.S. Application Data
(60) Provisional application No. 61/290,175, filed on Dec. 25, 2009.

(51) Int. Cl. H04B 1/44

(52) U.S. Cl. 455/78

(57) ABSTRACT

The present invention discloses an RF front-end circuit for a wireless communication device, which includes an RF terminal coupled to an antenna of the wireless communication device, for receiving or transmitting wireless signals; and a switch for connecting a plurality of processing modules to the RF terminal according to operations of the wireless communication device.

### CROSS REFERENCE TO RELATED APPLICATIONS

This application claims the benefit of U.S. Provisional Application No. 61/290,175, filed on Dec. 25, 2009 and entitled “RF Front-end Circuit and Wireless Device Using the Same”, the contents of which are incorporated herein by reference.

### BACKGROUND OF THE INVENTION

1. Field of the Invention

The present invention relates to a radio frequency (RF) front-end circuit, and more particularly, to a compact and less complex RF front-end circuit.

2. Description of the Prior Art

Wireless communication devices, such as wireless local area network (WLAN) devices, have become essential for exchanging information and are widely used in the modern society. Therefore, how to reduce the manufacturing cost as well as the price and simplify the manufacturing process of a wireless communication device has become a challenge in a design stage of the wireless communication device. For a dual-band wireless communication device such as a WLAN card supporting 2.4 GHz and 5 GHz communication, the challenge is even more difficult due to the complex circuit in the dual-band radio frequency (RF) front-end circuit.

Please refer to FIG. 1, which illustrates a conventional RF front-end circuit 100 within a conventional wireless communication device. The circuit 100 is used to transmit and receive signals using 2.4 GHz and 5 GHz frequencies, and includes an antenna 110, a broadband T/R (transmitting/receiving) switch 101, diplexers 102 and 103, low noise amplifiers 104 and 105, power amplifiers 106 and 107, and bandpass filters (BPFs) 108 and 109. The broadband T/R switch 101 is a dual-band switch, such as a single pole double throw (SPDT) switch, and utilized to switch between the operations of transmitting and receiving. The diplexers 102 and 103 are utilized to separate signals of the 5 GHz signal and the 2.4 GHz signals and to reduce the interference between these two signals, because the amplifiers 105 and 107 of the 5 GHz signals might oscillate due to the interference of the 2.4 GHz signals.

The architecture of the RF front-end circuit 100 is complex and requires many components. Therefore, it is difficult to reduce the size, cost and weight of the wireless communication device with the RF front-end circuit 100.

In addition, the diplexers 102 and 103 are passive units, while the broadband T/R switch 101 and the amplifiers 104-107 are active units. Thus, in a layout stage of manufacturing the RF front-end circuit 100, the diplexers 102 and 103 must be separately designed, and cannot be integrated into the wafer of the active units, which increases complexity and cost of the manufacturing process.

Moreover, the broadband T/R switch 101 might cause about 1 dB of insertion loss, while the diplexers 102 and 103 might cause 2 dB of insertion loss. This will reduce the output power of the wireless communication device and have negative impact to the receiving sensitivity of the wireless communication device.

Hence, there's a need to develop a compact and less complex RF front-end circuit.

### SUMMARY OF THE INVENTION

It is therefore a primary objective of the claimed invention to provide an RF front-end circuit and wireless communication device using the same.

The present invention discloses an RF front-end circuit for a wireless communication device, which comprises an RF terminal coupled to an antenna of the wireless communication device, for receiving or transmitting wireless signals; and a switch for connecting a plurality of processing modules to the RF terminal according to operations of the wireless communication device.

The present invention further discloses a wireless communication device using the RF front-end circuit mentioned above.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a conventional RF front-end circuit.

FIG. 2 illustrates an RF front-end circuit according to an embodiment of the present invention.

FIG. 3 illustrates an RF front-end circuit according to another embodiment of the present invention.

FIG. 4 illustrates an RF front-end circuit according to yet another embodiment of the present invention.

### DETAILED DESCRIPTION

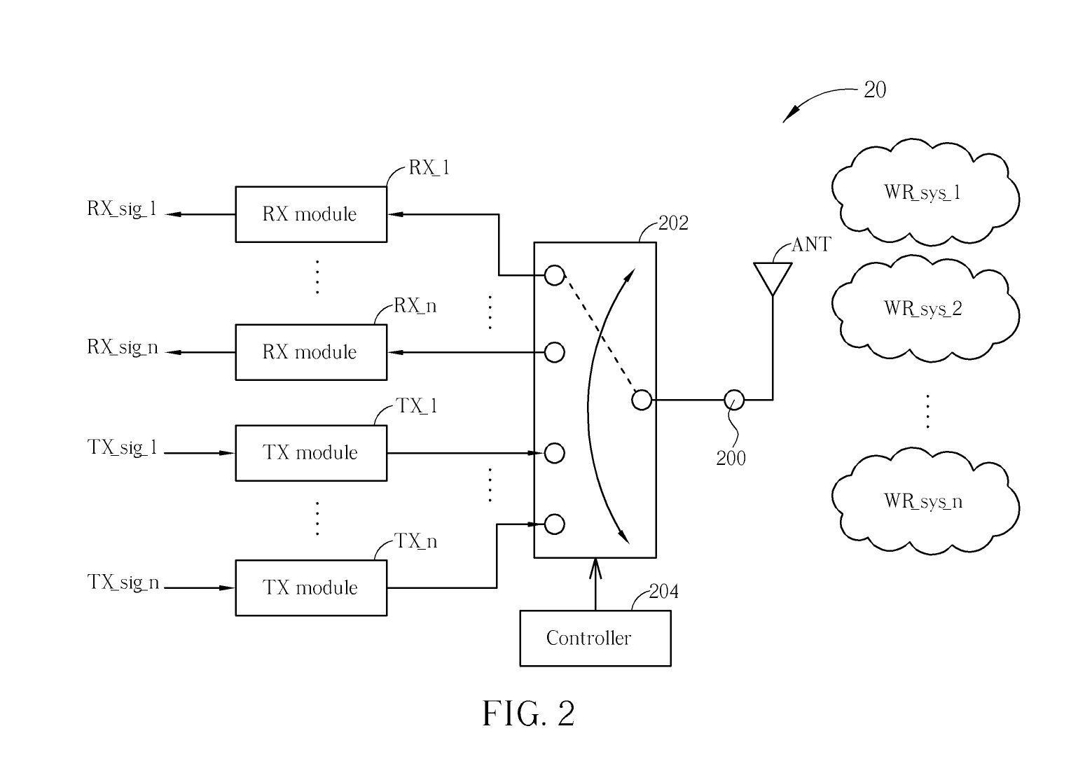

Please refer to FIG. 2, which illustrates a schematic diagram of an RF front-end circuit 20 for a wireless communication device according to an embodiment of the present invention. The RF front-end circuit 20 is utilized for processing RF signals of wireless communication systems WR_sys_1-WR_sys_n, which operate in different frequency bands. The RF front-end circuit 20 comprises an RF terminal 200, a switch 202, reception (RX) modules RX_1-RX_n, and transmission (TX) modules TX_1-TX_n. The RF terminal 200 is a terminal connecting the switch 202 and an antenna ANT of the wireless communication device, which represents that the RF front-end circuit 20 and the antenna ANT can be designed or manufactured separately. The RX modules RX_1-RX_n and the TX modules TX_1-TX_n can be nominated as processing modules for simplicity. The RX modules RX_1-RX_n are utilized for performing receiving operations, to output signals RX_sig_1-RX_sig_n to a baseband processing module or the like. The TX modules TX_1-TX_n are utilized for performing transmitting operations, to output signals TX_sig_1-TX_sig_n to the wireless communication systems WR_sys_1-WR_sys_n through the switch 202, the RF terminal 200, and the antenna ANT. The switch 202 is controlled by a control 204, and utilized for connecting one of the processing modules RX_1-RX_n and TX_1-TX_n to the RF terminal 200. For example, when the wireless communication device is to receive signals from the wireless communication system WR_sys_1, the control 204 controls the switch 202 to connect the RX module RX_1 and the RF terminal 200. When the wireless communication device is to transmit signals to the wireless communication system WR_sys_1, the control 204 controls the switch 202 to connect the TX module TX_1 and the RF terminal 200.

As can be seen, the RF front-end circuit 20 does not include passive units like diplexers or multiplexers for separating signals at different frequencies. Therefore, the RF front-end circuit 20 can be overall designed in the same stage, and can be integrated into the same wafer or chip, so as to reduce cost and complexity of the manufacturing process of the RF front-end circuit 20.

Note that, the RF front-end circuit 20 shown in FIG. 2 is utilized for describing the concept of the present invention, and can be modified or altered by those skilled in the art. For example, each of the RX modules RX_1-RX_n and the TX modules TX_1-TX_n shown in FIG. 2 is taken as a single processing module and connected to the switch 202; however, in another embodiment, multiple of the RX modules RX_1-RX_n or the TX modules TX_1-TX_n can be combined as a processing module and connected to the same port of the switch 202 while adding a matching circuit for separating signals of different wireless communication systems. Examples are shown below.

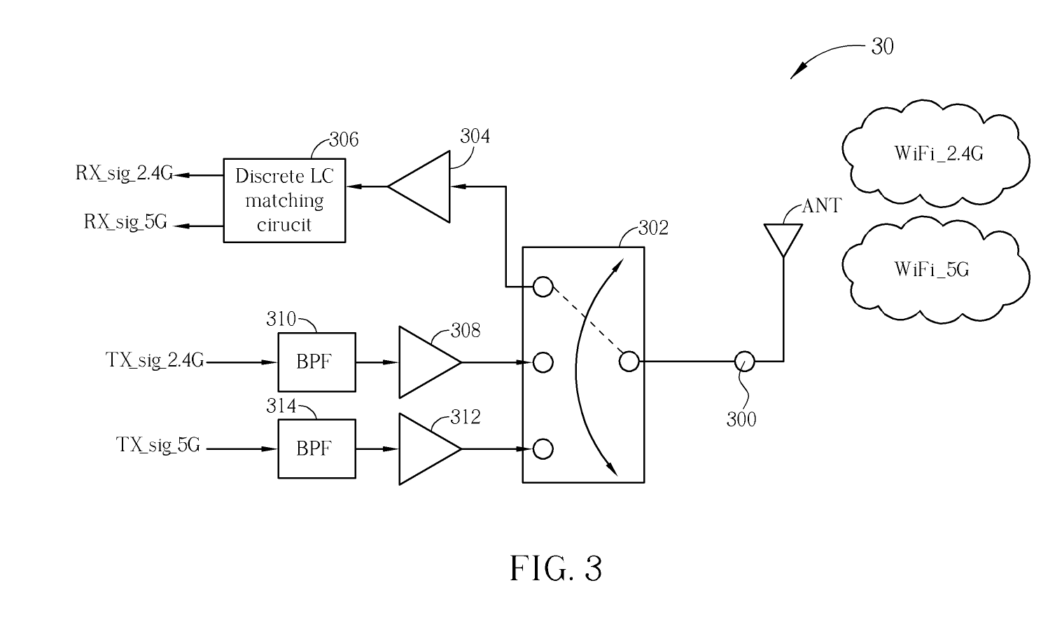

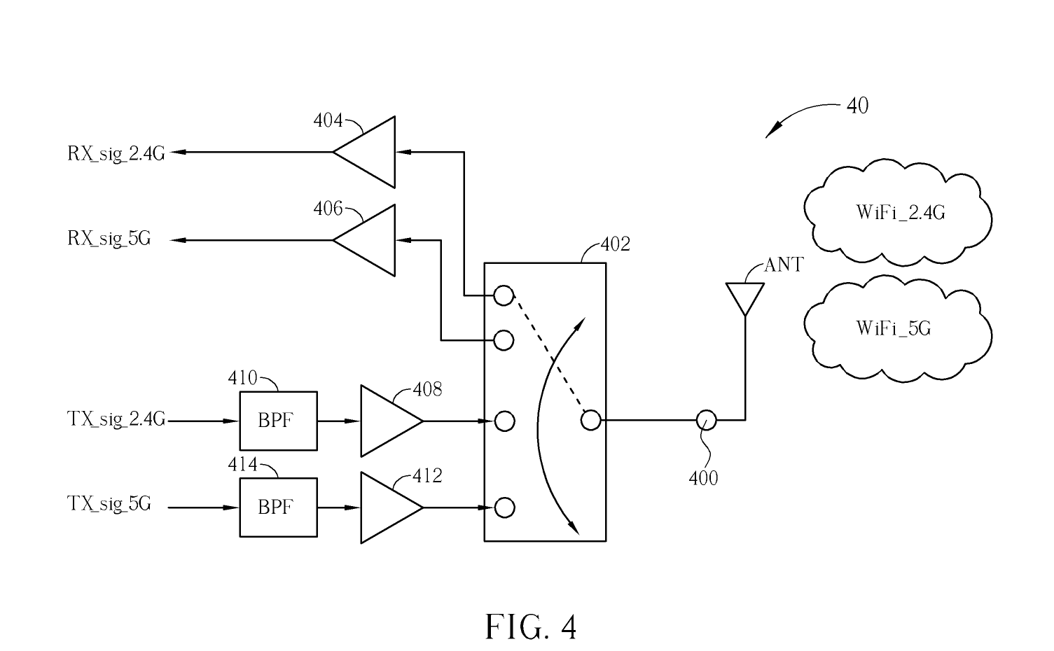

Please refer to FIG. 3 and FIG. 4, illustrating schematic diagrams of an RF front-end circuit 30 and an RF front-end circuit 40 according to embodiments of the present invention. Both of the RF front-end circuit 30 and the RF front-end circuit 40 support wireless communication systems WiFi_{—}2.4G and WiFi_{—}5G, which operate in frequency bands of 2.4 GHz and 5 GHz respectively, i.e. n=2 in view of the RF front-end circuit 20 shown in FIG. 2.

In detail, the RF front-end circuit 30 comprises an RF terminal 300, a switch 302, amplifiers 304, 308 and 312, a discrete LC matching circuit 306, and BPFs 310 and 314. The amplifier 304 is preferably a broadband low noise amplifier (LNA) used to amplify received signals at frequencies of 2.4 GHz and 5 GHz; thus, the amplifier 304 together with discrete LC matching circuit 306 implement a processing module composed of two reception modules for processing received signals at 2.4 GHz and 5 GHz, so as to output signals RX_sig_{—}2.4G or RX_sig_{—}5G to a baseband processing module or the like. The amplifier 308 and the BPF 310 implement a transmission module, to output signals TX_sig_{—}2.4G to the wireless communication systems WiFi@2.4G through the switch 302, the RF terminal 300, and the antenna ANT. Similarly, the amplifier 312 and the BPF 314 implement another transmission module, to output signals TX_sig_{—}5G to the wireless communication systems WiFi@5G through the switch 302, the RF terminal 300, and the antenna ANT.

In FIG. 3, the switch 302 is a Single Pole Triple Throw (SP3T) switch. That is, the two reception modules share the same port of the switch 302, and to separate received signals at 2.4 GHz and 5 GHz, the discrete LC matching circuit 306 is added. Note that, the discrete LC matching circuit 306 can be other circuits or units capable of separating signals at 2.4 GHz and 5 GHz.

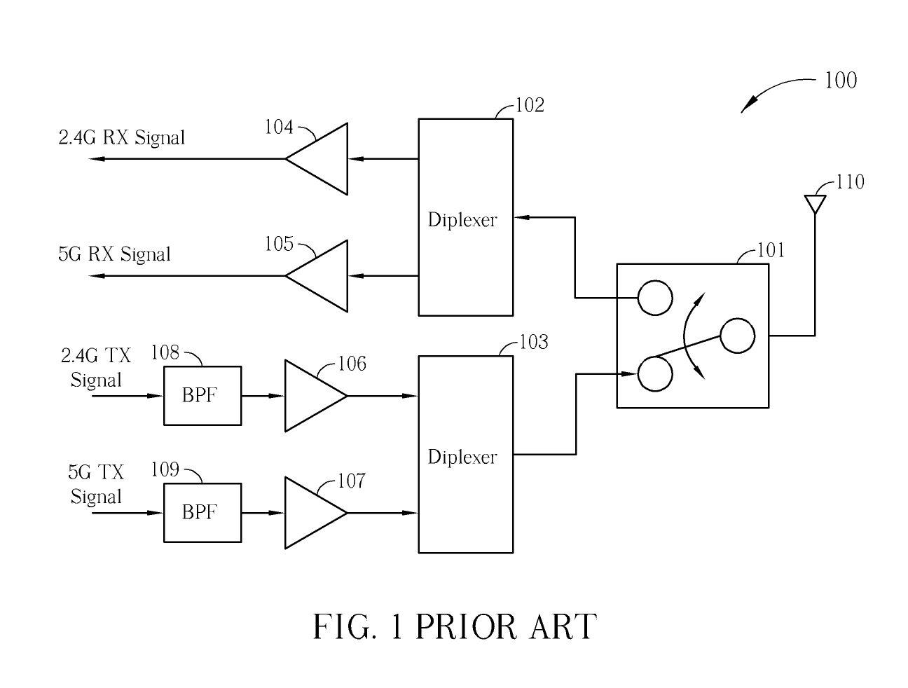

Comparing with the conventional RF front-end circuit 100 shown in FIG. 1, the diplexers 102 and 103 are not necessary in the RF front-end circuit 30. Thus, the 2 dB insertion loss caused by the diplexers is thus eliminated, and at the same time, the output power and the receiving sensitivity are improved. Moreover, the RF front-end circuit 30 provides a simpler architecture and the size occupied is reduced due to the less number of components used in the RF front-end circuit 30. Therefore, a wireless communication device that incorporated such circuit can be made smaller.

In addition, the ports of the switch 302 in the RF front-end circuit 30, which are connected to the amplifiers 308 and 312, can be easily designed because these two ports deal with signals at a single frequency, respectively. Therefore, the cost and time to develop the switch 302 can be focused on the port of the switch 302, which is connected to the amplifier 304, because it deals with dual-band signals. The time and cost to develop the wireless communication device are thus reduced.

Another advantage of the embodiment shown in FIG. 3 is that the isolations between each port of the switch 302 are improved, so the switch 302 can also act as a diplexer. The interference between each circuits that deal with received signals or transmitting signals are hence prevented.

A further advantage of the embodiment shown in FIG. 3 is that due to the elimination of the passive component, such as the diplexer, the amplifiers 304, 308 and 312 and the switch 302 can be integrated into one single chip. So the development of the RF front-end circuit 30 is easier and the size and cost of the module are also reduced.

Furthermore, in FIG. 4, the RF front-end circuit 40 comprises an RF terminal 400, a switch 402, amplifiers 404, 406, 408 and 412, and BPFs 410 and 414. The amplifiers 404 and 406 respectively implement reception modules for processing received signals at 2.4 GHz and 5 GHz, in order to output signals RX_sig_{—}2.4G or RX_sig_{—}5G to a baseband processing module or the like. The amplifier 408 and the BPF 410 implement a transmission module, to output signals TX_sig_{—}2.4G to the wireless communication systems WiFi@2.4G through the switch 402, the RF terminal 400, and the antenna ANT. Similarly, the amplifier 412 and the BPF 414 implement another transmission module, to output signals TX_sig_{—}5G to the wireless communication systems WiFi@5G through the switch 402, the RF terminal 400, and the antenna ANT. The switch 402 is a Single Pole Four Throw (SP4T) switch; thus, each of the processing modules occupies a port of the switch 402, i.e. amplifiers 404, 406, 408 and 412 are connected to four ports of the switch 402.

As mentioned in the previous embodiment, the development of the port of the switch 302, which is connected to the amplifier 304, is difficult because it has to deal with dual band signals. Besides, the broadband amplifier 304 also makes the design difficult. Hence, the RF front-end circuit 40 provides an alternative solution. The amplifiers 404, 406, 408 and 412 are respectively used to deal with signals at single bands. Thus, the components that are difficult to design, such as the broadband amplifier and the port of the switch that is connected to the broadband amplifier, are eliminated. Therefore, the RF front-end circuit 40 can provide the same advantage as the RF front-end circuit 30.

According to yet another embodiment of the present invention, a wireless communication device, such as a WLAN card or a WLAN USB dongle, can be provided with the RF front-end circuits mentioned in the aforementioned embodiments.

In summary, the RF front-end circuits of the present invention do not need diplexers, such that cost, complexity and time to manufacture the RF front-end circuits can be effectively reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radio frequency (RF) front-end circuit for a wireless communication device, comprising:
an RF terminal coupled to an antenna of the wireless communication device, for receiving or transmitting wireless signals; and
a switch for connecting a plurality of processing modules to the RF terminal according to operations of the wireless communication device.

2. The RF front-end circuit of claim 1, wherein the plurality of processing modules comprises:
a plurality of reception modules for processing received signals; and
a plurality of transmission modules for processing transmission signals.

3. The RF front-end circuit of claim 2, wherein the plurality of reception modules comprises:
a first reception module for processing a received signal of a first frequency; and
a second reception module for processing a received signal of a second frequency; and
the plurality of transmission modules comprises:
a first transmission module for processing a transmission signal of the first frequency; and
a second transmission module for processing a transmission signal of the second frequency.

4. The RF front-end circuit of claim 1, wherein a processing module of the plurality of processing modules comprises:
an amplifier coupled to the switch for amplifying a first received signals and a second received signal;
a first reception module for processing the first received signal;
a second reception module for processing the second received signals; and
a matching circuit coupled to the amplifier, the first reception module and the second reception module, for separating the first received signal and the second received signal.

5. The RF front-end circuit of claim 4, wherein the first received signal is received at a first frequency and the second received signal is received at a second frequency.

6. The RF front-end circuit of claim 1, further comprising a controller for controlling the switch according to the operations of the wireless communication device.

7. The RF front-end circuit of claim 1, wherein the plurality of wireless communication systems apply different frequency bands.

8. The RF front-end circuit of claim 1, wherein the switch is a single pole triple throw (SP3T) switch.

9. The RF front-end circuit of claim 1, wherein the switch is a single pole four throw (SP4T) switch.

10. A wireless communication device comprising a radio frequency front-end circuit of claim 1 for processing signals corresponding to a plurality of wireless communication systems.
